(19) United States
(12) Patent Application Publication
(10) Pub. No.: US 2025/0258761 A1
(43) Pub. Date: Aug. 14, 2025

(54) SYSTEM FOR IDENTIFICATION OF SECTION 508 VIOLATIONS IN SOURCE CODE DURING DEVELOPMENT

(71) Applicant: Booz Allen Hamilton Inc., McLean, VA (US)

(72) Inventor: Kevin Poorman, Seattle, WA (US)

(73) Assignee: Booz Allen Hamilton Inc., McLean, VA (US)

(21) Appl. No.: 19/005,206

(22) Filed: Dec. 30, 2024

Related U.S. Application Data
(60) Provisional application No. 63/551,849, filed on Feb. 9, 2024.

(51) Int. Cl. G06F 11/3668

(52) U.S. Cl. CPC G06F 11/3692

(57) ABSTRACT

Embodiments relate to methods and systems for configuring a processor to efficiently search a datafile of programming code that drives a graphical user interface (“GUI”), and to ensure integration of sensory characteristics (e.g., audio, visual, tactile, etc.) associated with displayed information (e.g., for Section 508 or other government regulations). The system can include a processor and a memory having instructions stored thereon that when executed by the processor will cause the processor to: monitor a programming code construct to identify a specified interconnection, or an absence thereof, for compliance with a rules-based protocol (e.g., a rule associated with a government regulation) governing implementation of programming code; generate a tag for the programing code construct; and generate a report including the tagged programming code construct as being compliant or not with the rules-based protocol.

### CROSS-REFERENCE TO RELATED APPLICATIONS

This patent application is related to and claims the benefit of priority of U.S. Provisional Patent Application No. 63/551,849, filed Feb. 9, 2024, the entire contents of which is incorporated herein by reference.

### FIELD

Embodiments can relate to systems and methods for identifying deficiencies or errors in source code that, if not corrected for, will generate a user interface having feature(s) that are in violation of Section 508 of the Rehabilitation Act (requiring accessibility and compliance for disabled persons).

### BACKGROUND INFORMATION

Known systems/methods have no means to determining accessibility and compliance during the development stage (e.g., when code is developed and edited); rather one has to wait until the user interface is developed and implemented to perform a review for Section 508 violations. Known systems and methods can be appreciated from U.S. Pat. No. 8,090,800 to Yee, U.S. Pat. No. 9,996,613 to Jadav et al., U.S. Pat. No. 11,262,979 to Deshmukh et al., U.S. Pat. No. 11,544,176 to Pandurangarao et al., U.S. Pat. No. 11,847,432 to Madhugiri, U.S. 20220/121723 to Page et al., WO 20222/26259 to Salehnamadi et al., Feiner, J., Krainz, E., Andrews, K., Hammoudi, S., Smialek, M., Camp, O., & Filipe, J. (2018 February). A New Approach to Visualise Accessibility Problems of Mobile Apps in Source Code. In ICEIS (2) (pp. 519-526), Chen, S., Chen, C., Fan, L., Fan, M., Zhan, X., & Liu, Y. (2021). Accessible or Not? An Empirical Investigation of Android App Accessibility. IEEE Transactions on Software Engineering, 48(10), 3954-3968. See section 3.1.1, and Kobori, K., Matsushita, M., & Inoue, K. (2015 March). Evolution Analysis for Accessibility Excessiveness in Java. In 2015 IEEE 22nd International Conference on Software Analysis, Evolution, and Reengineering (SANER) (pp. 83-90). IEEE. See highlighted sections.

### SUMMARY

An exemplary embodiment can relate to a system for configuring a processor to efficiently search a datafile of programming code that drives a graphical user interface (“GUI”), and to ensure integration of sensory characteristics (e.g., audio, visual, tactile, etc.) associated with displayed information (e.g., for Section 508 or other government regulations). The system can include a processor and a memory having instructions stored thereon that when executed by the processor will cause the processor to: monitor a programming code construct to identify a specified interconnection, or an absence thereof, for compliance with a rules-based protocol (e.g., a rule associated with a government regulation) governing implementation of programming code generate a tag for the programing code construct; and generate a report including the tagged programming code construct as being compliant or not with the rules-based protocol.

An exemplary embodiment can relate to a method for configuring a processor to efficiently search a datafile of programming code that drives a graphical user interface (“GUI”), and to ensure integration of sensory characteristics associated with displayed information. The method can involve: monitoring a programming code construct to identify a specified interconnection, or an absence thereof, for compliance with a rules-based protocol governing implementation of programming code; generating a tag for the programing code construct; and generating a report including the tagged programming code construct as being compliant or not with the rules-based protocol.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system diagram;

FIG. 2 shows another exemplary system diagram;

FIG. 3 shows an exemplary process flow diagram; and

FIGS. 4A-4E show an exemplary report generated by an embodiment of the system.

### DETAILED DESCRIPTION

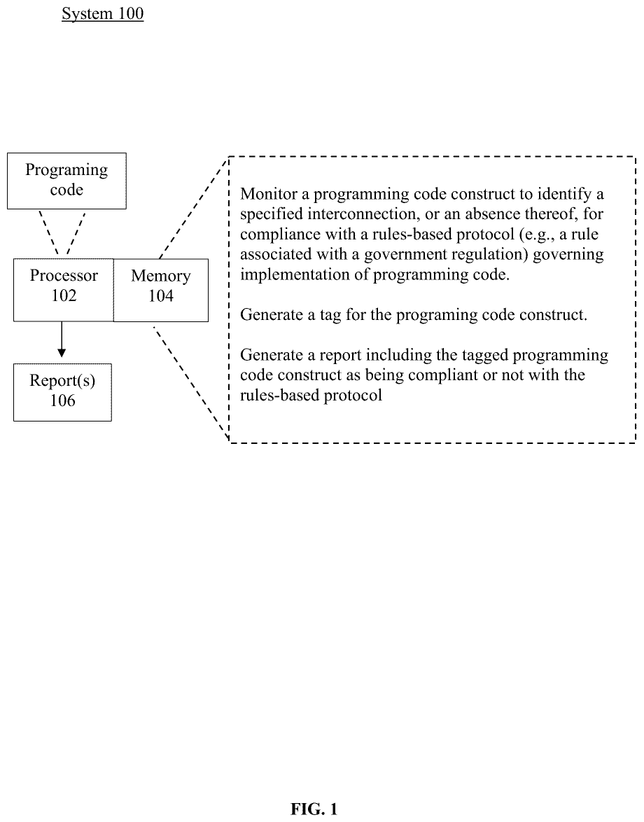

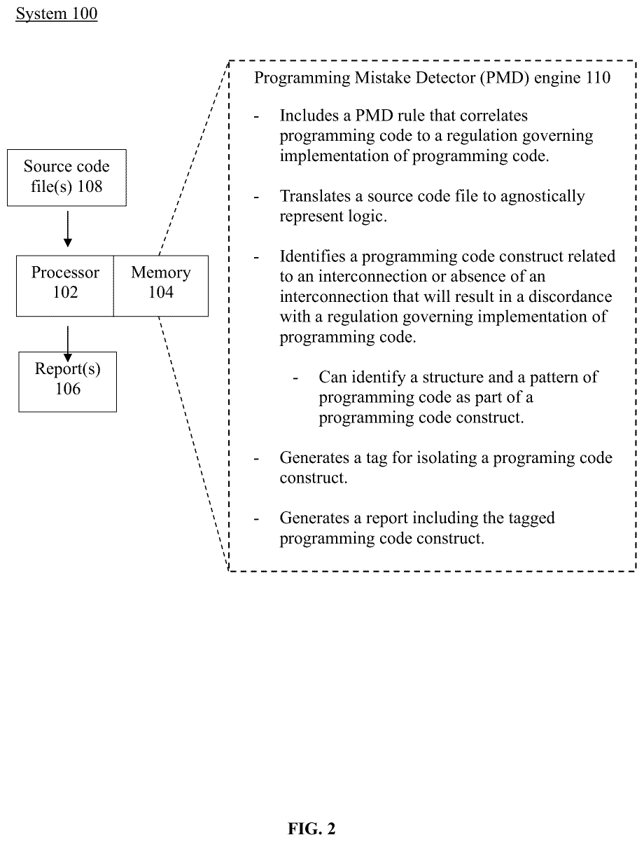

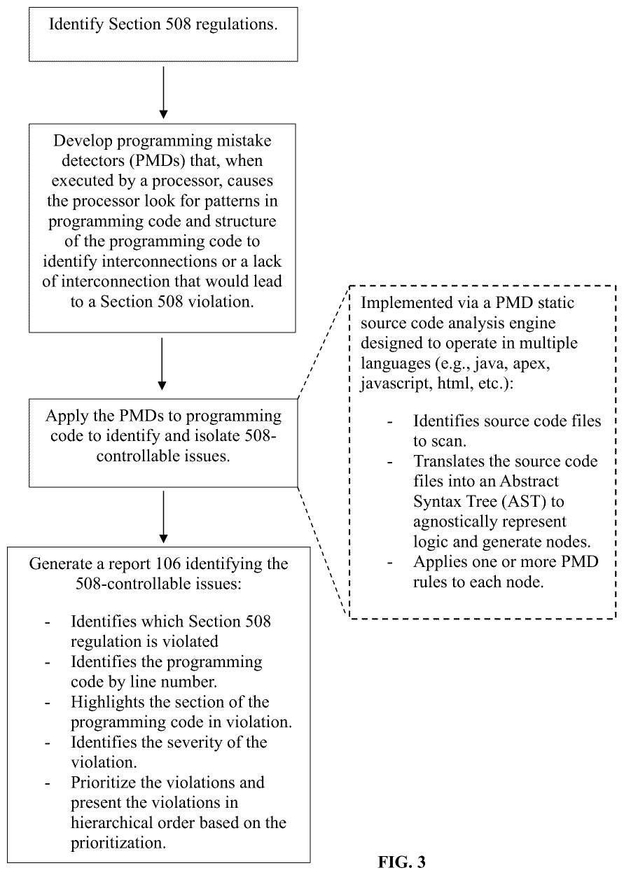

Referring to FIGS. 1-4, embodiments can relate to systems 100 and methods for identifying deficiencies or errors in source code that, if not corrected for, will generate a user interface having feature(s) that are in violation of Section 508 of the Rehabilitation Act (requiring accessibility and compliance for disabled persons). Exemplary embodiments use programming mistake detectors (“PMDs”) that allow for static source code analysis to be applied to programming code to identify and isolate 508-controllable issues. The PMDs can be sets of programming code and rules that correlate Section 508 requirements to programming code. For instance, a PMD can be rule that reviews programing code to identify any image tag that does not also have an alt tag. An alt tag associated with an image tag causes a screen reader to read aloud the image, and thus Section 508 requires all image tags to also include an alt tag. Therefore, programming codes that has an image tag without an alt tag would be a violation (e.g., in non-compliance with a rule related to Section 508). The PMDs can be generated in XPath, Java, etc. PMD selectors (e.g., XPath language, Java language, etc.) can be designed to look for patterns in the programming code and structure of the programming code to identify interconnections or a lack of interconnection (e.g., an image tag without an alt tag) that would lead to a Section 508 violation. The system 100 can be implemented as programmers are developing or editing programming code. In addition, or in the alternative, the system can be implemented after the programming code has been developed or edited—e.g., as part of a quality assurance check for example.

An exemplary embodiment can relate to a system 100 for configuring a processor 102 to efficiently search a datafile of programming code that drives a graphical user interface (“GUI”), and to ensure integration of sensory characteristics associated with displayed information. For instance, programming code driving the GUI may or may not have rules-based protocols governing implementation of the programming code. These rules-based protocols can relate to sensory characteristics associated with the display of information via the GUI. For instance, the rules-based protocol might require an audio prompt to be associated with a certain image. The system 100 can cause the processor 102 to search programming code (as it is being developed/edited, after it is developed/edited, or both) to identify whether the programming code is in compliance with the rules-based protocol. This can ensure that development/editing of the programming code integrates the sensory characteristic (e.g., audio prompt, visual prompt, tactile prompt, etc.) governed by the rules-based protocol. Note, this can be done before the GUI is ever implemented—e.g., this can be done during development or editing of the programming code for the GUI.

While it is contemplated for the programming code to be code that drives a GUI, it need not be limited to programming code for a GUI. Rather the programming code can be for any operation performed by a computer or processor. In addition, the system 100 is not necessarily limited to integration of sensory characteristics associated with displayed information. Rather, the system 100 can ensure whether the programming code has any type of interconnection (discussed in detail later) or absence of interconnection that is in discordance with rules-based protocol.

The system 100 can include a processor 102. The system 100 can include a memory 104. The memory 104 can have instructions stored thereon that when executed by the processor 102 will cause the processor 102 to perform one or more of the functions disclosed herein—e.g., execute algorithmic steps for implementing any of the methods or method steps disclosed herein.

The processor 102 can be any of the processors 102 disclosed herein. The processor 102 can be part of or in communication with a machine (e.g., a computer device, a logic device, a circuit, an operating module (hardware, software, and/or firmware), etc.). The processor 102 can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. It should be noted that use of processors 102 herein can include any one or combination of a Graphics Processing Unit (GPU), a Field Programmable Gate Array (FPGA), a Central Processing Unit (CPU), etc. The processor 102 can include one or more processing or operating modules. A processing or operating module can be a software or firmware operating module configured to implement any of the method steps disclosed herein. The processing or operating module can be embodied as software and stored in memory 104, the memory 104 being operatively associated with the processor 102. A processing module can be embodied as a web application, a desktop application, a console application, etc.

The processor 102 can include or be associated with a computer or machine readable medium. The computer or machine readable medium can include memory 104. Any of the memory 104 discussed herein can be computer readable memory configured to store data. The memory 104 can include a volatile or non-volatile, transitory or non-transitory memory, and be embodied as an in-memory, an active memory, a cloud memory, etc. Embodiments of the memory 104 can include a processor module and other circuitry to allow for the transfer of data to and from the memory 104, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The computer or machine readable medium can be configured to store one or more instructions thereon. The instructions can be in the form of algorithms, program logic, etc. that cause the processor 102 to execute any of the method steps disclosed herein.

The processor 102 can be in communication with other processors of other devices (e.g., a computer device, a computer system, a laptop computer, a desktop computer, etc.). Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two or more applications to talk to each other. Use of an API can allow software of the processor 102 of the system 100 to communicate with software of the processor of the other device(s), if the processor 102 of the system 100 is not the same processor of the device.

The instructions can cause the processor 102 to monitor one or more programming code constructs to identify a specified interconnection, or an absence thereof, for compliance with a rules-based protocol governing implementation of programming code(s). For instance, the processor 102 can monitor programming code to determine whether the programming code includes an image tag that also does not have an alt tag—e.g., this is an example of an absence of an interconnection. The interconnection in this case is that programming code that has an image tag should also have an alt tag, and therefore programming code that has an image tag without an alt tag is an absence of an interconnection. The processor 102 can be configured to monitor the programming code for one or more interconnections, absence of one or more interconnections, or both. The interconnection(s) or absence of interconnection(s) can be determined by one or more rules-based protocols designed to govern the implementation of the programming code. The processor 102 can monitor for any number of interconnections in series, in parallel, iteratively, recursively, etc.

The instructions can cause the processor 102 to generate a tag for the programing code construct. For instance, the processor 102 can encode the datafile with an indicator, metadata, etc. that identifies the programming code, a section of the programming code, a line of the programming code, etc. that has the interconnection or absence of interconnection. There can be a tag for an interconnection, a tag for a group of interconnections, a tag for an absence of an interconnection, a tag for a group of absent interconnections, etc.

The instructions can cause the processor 102 to generate a report 106. The report 106 can include the tagged programming code construct. The report 106 can include the tagged programming code construct as being compliant or not with the rules-based protocol. Being compliant means that the tagged programming code has the interconnection(s) or absence of interconnection(s) dictated by the rules-based protocol. Being non-compliant means that the tagged programming code is missing at least one interconnection or absence of an interconnection. There can be any number of reports 106. There can be a report 106 for programming code tagged for a specified interconnection or absence thereof, a report 106 for programming code tagged for a group of specified interconnections or absence thereof, a report 106 for programming code that is in compliance, a report for programming code that is not in compliance, etc.

It is contemplated for the rules-based protocol governing implementation of programming code to include compliance with rules related to disability accessibility and disability safety. For instance, the rules can be related to disability accessibility and disability safety to include Section 508 of the Rehabilitation Act (“Section 508”), or other government regulation. However, the rules-based protocol need not be limited to a government regulation, or limited to rules related to disability accessibility and disability safety. Rather, the rules-based protocol can be rules governing implementation of the programming code for purposes of efficiency, standardization, continuity, to avoid operability issues, etc.

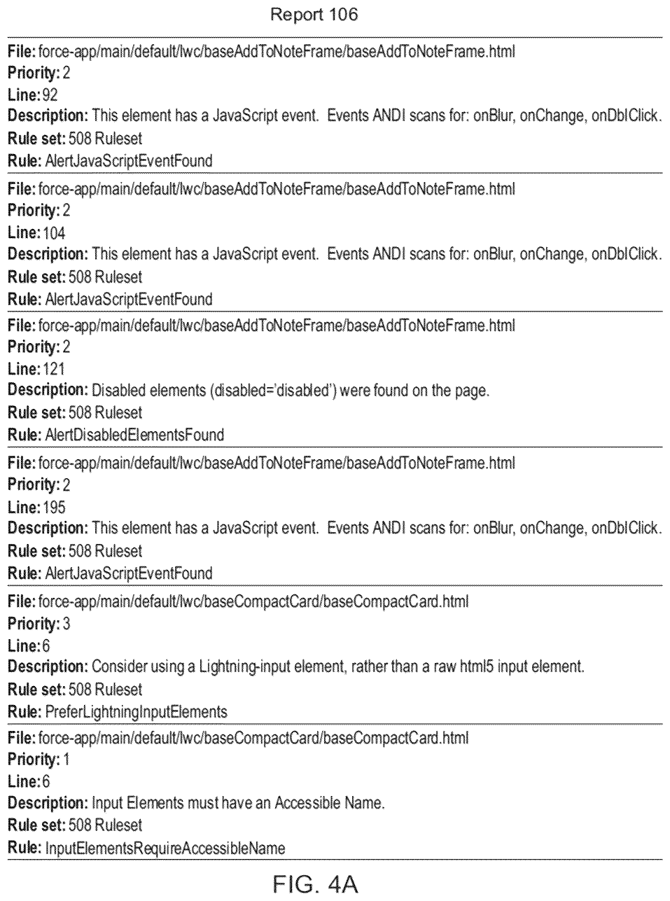

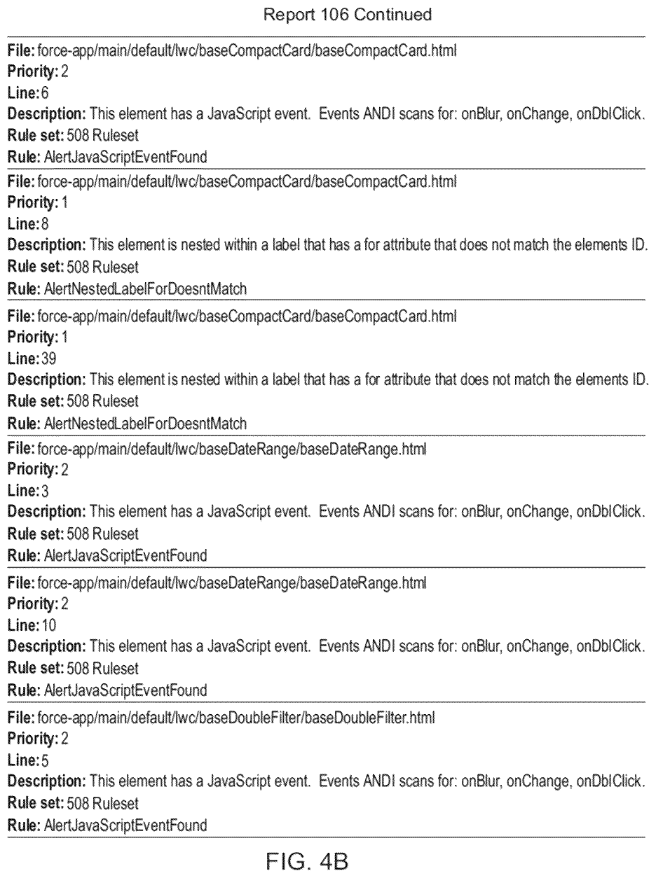

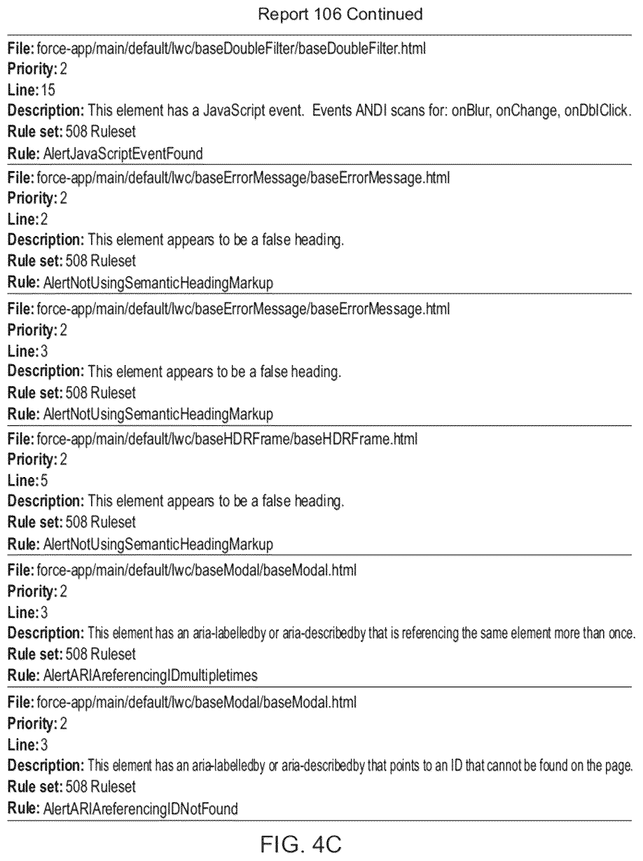

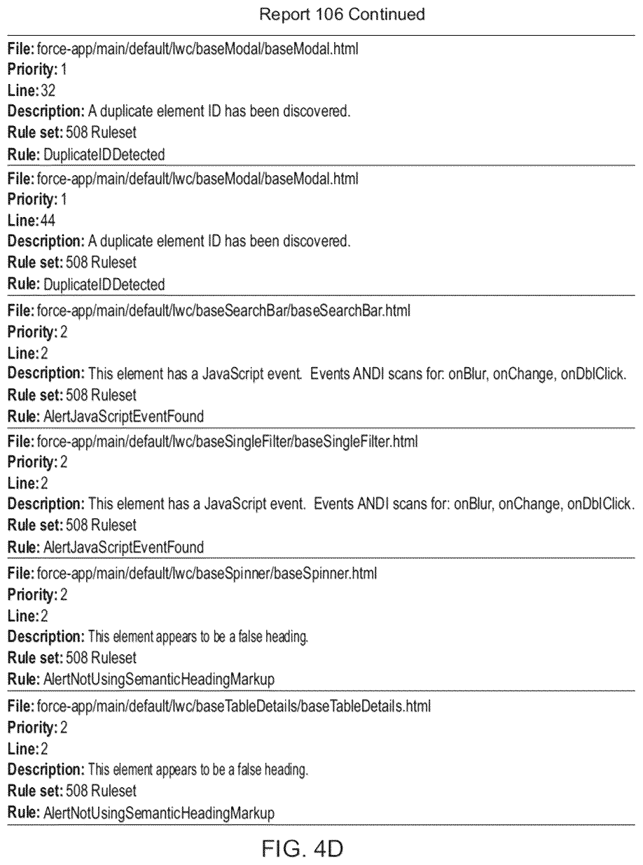

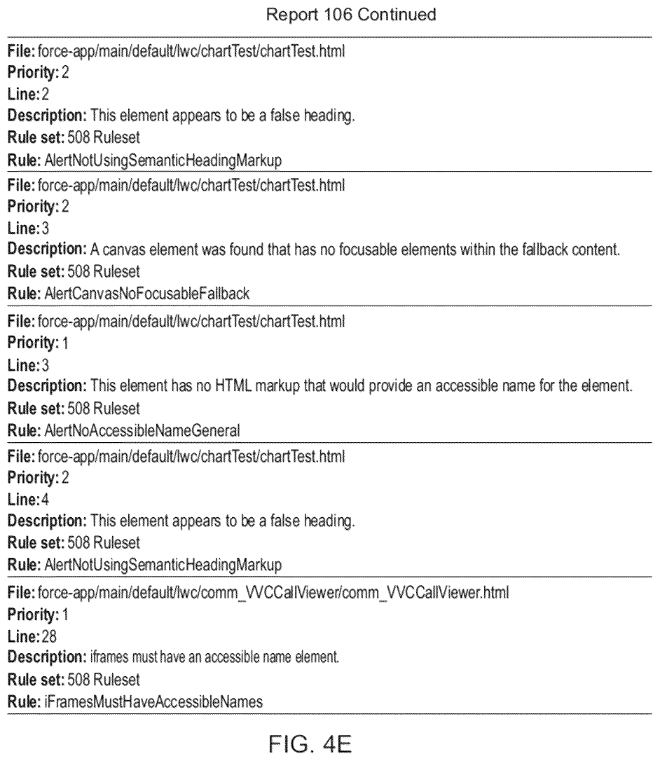

Sticking with the example of the rules-based protocols being related to Section 508, the report 106 can be generated to identify at least one or more of: an instance of Section 508 non-compliance; programming code by line number leading to the instance of Section 508 non-compliance; a severity of the instance of Section 508 non-compliance; and/or a prioritized list of instances of Section 508 non-compliance. An exemplary report 106 is illustrated in FIGS. 4A-4E. The instance of Section 508 non-compliance can be a tagged programming code that is non-compliant with the rules-based protocol. The report 106 can identify any number of instances of 508 non-compliance. As will be explained herein, the processor 102 can have access to the source code file of the programming code, and thus can identify the tagged programming code by line number. Thus, the processor 102 can generate a report 106 identifying the tagged programming code by line number. The rules-based protocol can prescribe a consequence(s) of non-compliance (e.g., breaking the law, reduction in efficiency, preclusion of standardization, prevention of continuity, reduction in operability, etc.) which can be translated into a severity of non-compliance. In addition, the number of non-compliant instances a specific programming code has can also influence the severity of non-compliance.

The report 106 can include any number of instances of non-compliance and tagged programming codes. The report can prioritize the instances and tagged programming code by ranking them (e.g., assigning a value to them), generating a segmented report (e.g., a high priority table, a low priority table, etc.), color coding the instances/programming code, etc. The prioritization can be based on severity of non-compliance, ease of correction, a cost-benefit analysis (e.g., via a cost or objective function) or allowing or fixing the non-compliance, etc.

The instructions can cause the processor 102 to identify a structure and a pattern of programming code as part of the programming code construct. Programming code has structure and patterns associated with it. The processor 102 can monitor the programming code to identify structures and patterns which can be used to identify interconnections or absence of interconnections within the programing code.

The instructions can cause the processor 102 to monitor the programming code construct of programming code in a source code file 108. For instance, the system 100 can be configured to scan source code files of the programming code to perform the functions disclosed herein.

The processor 102 can include a programming mistake detector (PMD) engine 110 (e.g., a core component of a software application that powers its functionality by pre-packaging complex systems into a reusable component). The PMD engine 110 can be configured to monitor the programming code construct via a static source code analysis technique; however, other analytic techniques can be used. The PMD engine 110 can be configured to operate in one or more programming languages (e.g., java, apex, javascript, html, etc.). The PMD engine 110 can include one or more PMD rules that correlate(s) programming code to the rules-based protocol governing implementation of programming code. For example, the PMD rule can encode a requirement of the rules-based protocol that correlates with programming code. For instance, suppose the rules-based protocol requires there to be an audio output whenever a certain image is displayed via the GUI. The PMD rule, depending on the programming language, can be an executable that scans a source code file to monitor programming code for an image tag that also has an alt tag (this is for XPath language) as an interconnection that would satisfy this requirement. In addition, or in the alternative, the PMD rule can be an executable that scans a source code file to monitor programming code for an image tag that does not also have an alt tag. These examples are how the PMD rule can correlate the rules-based protocol requirement(s) with programming code. As noted herein, the rules-based protocols may have a consequence associated to non-compliance. The PMD rule can encode a severity which with a non-compliance instance corresponds to a consequence. For instance, if a non-compliant consequence results in a fine, a severity ranking number can be associated with the non-compliance based on the amount of the fine. If the non-compliance consequence results in a reduction in business continuity, a severity ranking number can be associated with the non-compliance based on the expected/predicted/anticipated cost of the disruption.

Exemplary PMD rules for Section 508 as the rules-based protocol and for PMD rule XPath language are presented below:

The PMD engine 110 can be configured to identify a source code file 108 to scan to monitor the programming code construct. For instance, the PMD engine 110 can have access to a repository of source code file(s) 108. Based on encoded data (e.g., metadata), the PMD engine 110 can determine which source code files 108 to scan or not scan based on the rules-based protocol intended to be reviewed.

Once the source code file(s) is/are selected, the PMD engine 110 can be configured to translate the source code file(s) 108 to agnostically represent logic. This can be done to agnostically represent one or more logic constructs of the programming code. For instance, the PMD engine 110 can be configured to translate the source code file 108, or any portion thereof, into an Abstract Syntax Tree (AST). After the translation, the PMD engine 110 can generate one or more nodes (e.g., a data structure node) representing an agnostic translation of the source code file(s) 108. The PMD engine 110 can then apply one or more PMD rule(s) to the node(s).

An exemplary embodiment can relate to a method for configuring a processor 102 to efficiently search a datafile of programming code that drives a graphical user interface (“GUI”), and to ensure integration of sensory characteristics associated with displayed information. The method can involve monitoring a programming code construct to identify a specified interconnection, or an absence thereof, for compliance with a rules-based protocol governing implementation of programming code. The method can involve generating a tag for the programing code construct. The method can involve generating a report 106 including the tagged programming code construct as being compliant or not with the rules-based protocol.

It is contemplated for the rules-based protocol governing implementation of programming code to include compliance with rules related to disability accessibility and disability safety.

It is contemplated for the rules related to disability accessibility and disability to include Section 508 of the Rehabilitation Act (“Section 508”).

The method can involve presenting, via the report 106, at least one or more of: an instance of Section 508 non-compliance; programming code by line number leading to the instance of Section 508 non-compliance; a severity of the instance of Section 508 non-compliance; and/or a prioritized list of instances of Section 508 non-compliance.

The method can involve identifying a structure and a pattern of programming code as part of the programming code construct.

In some embodiments, monitoring the programming code construct can involve monitoring the programming code construct of programming code in a source code file. The method can further involve translating the source code file to agnostically represent logic.

It will be understood that modifications to the embodiments disclosed herein can be made to meet a particular set of design criteria. For instance, any of the components, features, or steps of the system or method can be any suitable number or type of each to meet a particular objective. Therefore, while certain exemplary embodiments of the systems and methods disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A system for configuring a processor to efficiently search a datafile of programming code that drives a graphical user interface (“GUI”), and to ensure integration of sensory characteristics associated with displayed information, the system comprising:
a processor;
a memory having instructions stored thereon that when executed by the processor will cause the processor to:
monitor a programming code construct to identify a specified interconnection, or an absence thereof, for compliance with a rules-based protocol governing implementation of programming code;
generate a tag for the programing code construct; and
generate a report including the tagged programming code construct as being compliant or not with the rules-based protocol.

2. The system of claim 1, wherein:
the rules-based protocol governing implementation of programming code includes compliance with rules related to disability accessibility and disability safety.

3. The system of claim 2, wherein:
the rules related to disability accessibility and disability safety include Section 508 of the Rehabilitation Act (“Section 508”).

4. The system of claim 3, wherein:
the report identifies at least one or more of:
an instance of Section 508 non-compliance;
programming code by line number leading to the instance of Section 508 non-compliance;
a severity of the instance of Section 508 non-compliance; and/or
a prioritized list of instances of Section 508 non-compliance.

5. The system of claim 1, wherein instructions will cause the processor to:
identify a structure and a pattern of programming code as part of the programming code construct.

6. The system of claim 1, wherein instructions will cause the processor to:
monitor the programming code construct of programming code in a source code file.

7. The system of claim 1, wherein:
the processor includes a programming mistake detector (PMD) engine configured to monitor the programming code construct via a static source code analysis technique.

8. The system of claim 7, wherein:
the PMD engine is configured to operate in one or more programming languages.

9. The system of claim 8, wherein:
the PMD engine includes a PMD rule that correlates programming code to the rules-based protocol governing implementation of programming code.

10. The system of claim 9, wherein:
the PMD engine is configured to identify a source code file to scan to monitor the programming code construct.

11. The system of claim 10, wherein:
the PMD engine is configured to translate the source code file to agnostically represent logic.

12. The system of claim 11, wherein:
the PMD engine is configured to translate the source code file into an Abstract Syntax Tree (AST).

13. The system of claim 12, wherein:
the PMD engine is configured to generate a node representing an agnostic translation of the source code file.

14. The system of claim 13, wherein:
the PMD engine is configured to apply the PMD rule to the node.

15. A method for configuring a processor to efficiently search a datafile of programming code that drives a graphical user interface (“GUI”), and to ensure integration of sensory characteristics associated with displayed information, the method comprising:
monitoring a programming code construct to identify a specified interconnection, or an absence thereof, for compliance with a rules-based protocol governing implementation of programming code;
generating a tag for the programing code construct; and
generating a report including the tagged programming code construct as being compliant or not with the rules-based protocol.

16. The method of claim 15, wherein:
the rules-based protocol governing implementation of programming code includes compliance with rules related to disability accessibility and disability safety.

17. The method of claim 16, wherein:
the rules related to disability accessibility and disability safety include Section 508 of the Rehabilitation Act (“Section 508”).

18. The method of claim 17, comprising:
presenting, via the report, at least one or more of:
an instance of Section 508 non-compliance;
programming code by line number leading to the instance of Section 508 non-compliance;
a severity of the instance of Section 508 non-compliance; and/or
a prioritized list of instances of Section 508 non-compliance.

19. The method of claim 15, comprising:
identifying a structure and a pattern of programming code as part of the programming code construct.

20. The method of claim 14, wherein:
monitoring the programming code construct includes monitoring the programming code construct of programming code in a source code file; and
translating the source code file to agnostically represent logic.
